(19) United States
(12) Patent Application Publication
(10) Pub. No.: US 2010/0213129 A1
(43) Pub. Date: Aug. 26, 2010

(54) APPARATUS AND METHOD FOR PURIFYING WATER BY FORWARD OSMOSIS

(75) Inventors: Richard A. L. Jones, Sheffield (GB); Anthony J. Ryan, Sheffield (GB); Helen Storey, London (GB); Malcolm Butler, Sheffield (GB); Colin James Crook, Sheffield (GB)

Correspondence Address: CLARK & ELBING LLP, 101 FEDERAL STREET, BOSTON, MA, 02110, US

(73) Assignee: The University of Sheffield, Sheffield (GB)

(21) Appl. No.: 12/514,752

(22) PCT Filed: Nov. 13, 2007
(86) PCT No.: PCT/GB2007/004314

§ 371 Date: Mar. 2, 2010

(30) Foreign Application Priority Data
Nov. 13, 2006 (GB) 0622520.5

(51) Int. Cl. C02F 1/44; B01D 61/08

(52) U.S. Cl. 210/652; 210/321.64

(57) ABSTRACT

A water purification apparatus comprising a semi-permeable membrane capable of being contacted with a water source; a superabsorbent polymer capable of absorbing water across said semi-permeable membrane; a pressure application surface capable of transmitting pressure to the gel; and a permeable membrane through which absorbed water is capable of being released from the gel upon application of pressure thereto from said pressure application surface, wherein said permeable membrane is isolated in use from the water source by an isolation means

The present application relates to a water purification apparatus and associated methods, in particular to water purification apparatus and methods employing forward osmosis.

### BACKGROUND

The lack of potable water is a problem in many regions of the world. Sea water, brackish water, and contaminated water sources are often the only water source available.

Examples of water pollutants include both chemicals and pathogens. Chemical pollutants can be toxic or even carcinogenic. In addition, the alteration of the physical chemistry of water sources, for example by altering acidity, conductivity, temperature, and excessive nutrient loading (eutrophication) can result in contaminated water.

Water sources can act as disease vectors for pathogens, causing human and animal disease. The World Health Organization defines waterborne diseases as those which generally arise from the contamination of water by faeces or urine, infected by pathogenic viruses or bacteria, and which are directly transmitted when unsafe water is drunk or used in the preparation of food. Examples of waterborne diseases includes Amebiasis, Campylobacteriosis, Cholera, Cryptosporidiosis, Cyclosporiasis, Giardiasis, Hepatitis, Salmonellosis, Shigellosi, Schistosomiasis, Typhoid fever and Viral gastroenteritis.

Travel to remote regions of the world, where a fresh water source is not readily available, requires the traveller to carry source of potable water. Where a traveller intends to remain in a remote location for an extended period of time, this is not always a viable option, due to the size and weight sufficient potable water. To overcome this problem, travellers often carry a portable water purification apparatus, which can be used to purify contaminated and/or saline water sources. Several portable systems for purifying contaminated water or sea water/brackish water (together defined as saline water) have been described.

Many portable water purification apparata employ pump filters are having ceramic filters that filter 5,000 to 50,000 litres per cartridge. Some also utilize activated charcoal filtering. However, most filtration devices of this type do not remove viruses, so additional disinfection by chemicals or ultraviolet light is required following filtration. This requires the user to carry a source of chemical additives such as chlorine, chlorine dioxide, iodine, and sodium hypochlorite (bleach) or a UV source.

Chemical disinfectant kits present one method by which contaminated water can be purified. For example, the addition of iodine to water kills many, but not all common waterborne pathogens. However, the traveller is required to carry sufficient disinfecting agent for the length of their journey. In addition, chemical disinfectants of this type are unable to purify saline water sources.

Forward or natural osmosis has also been used for desalination. Forward osmosis involves a container having two compartments separated by a semi-permeable membrane. The first compartment contains saline water. The second compartment contains an osmotic agent that generates a concentration gradient between the saline water in the first compartment and the second compartment. The concentration gradient draws water from the saline water across the semi-permeable membrane. The semi-permeable membrane permits water to pass into the second compartment but not salt. The water entering the second compartment dilutes the osmotic agent. The osmotic agents are then removed from the solution in the second compartment to generate potable water.

U.S. Pat. No. 4,443,336 describes a water purifying system unit that is portable, fabricated of durable parts and makes provision for storage of basic survival needs in addition to water. A double chamber unit with a bag and filter with a separating filter and storage compartment provides a three stage filtration of water. An appropriate mouthpiece makes drinking directly from the unit possible. Water is manually forced through a filter and a charcoal filled element.

WO 03/053348 describes a hydration bag for providing potable or even sterile water from contaminated water sources. The application discloses a passive membrane device comprising a sealable nutrient/osmotic agent chamber with a spiral wound membrane wrapped around the nutrient/osmotic agent chamber to form the membrane element, wherein the membrane element is located within a sealable dirty water compartment or within a dirty water source and wherein the membrane element communicates with a clean water compartment. The osmotic agent or nutrient can be a partially dehydrated food source, a sugar, a medicine, or combinations thereof, which is can be consumed with the purified water. To operate the spiral wound membrane element, nutrient powder or syrup (the osmotic agent) is introduced into an osmotic agent chamber through an osmotic agent port. The osmotic agent port is plugged, and the spiral wound membrane element is placed in any available water. The element operation is unhindered by highly turbid dirty water. The available or dirty water is contained in a dirty water chamber or bag that is carried or worn. Ambient or available water from a questionable source is used to fill the dirty water chamber through an opening. Initially water is pulled through the membrane element because, during filling of the osmotic agent or nutrient powder, a small amount of the powder migrates from the osmotic agent chamber through the transfer holes into the nutrient channel and comes into contact with the membrane. When the dirty water is introduced, this osmotic agent in the form of a dry powder or syrup hydrates by osmotically pulling water from the dirty water channel across the membrane. A diluted clean (nutrient) solution then fills the nutrient channel, and some of the solution enters the osmotic agent chamber, gradually diluting the nutrient there. The diluted clean nutrient solution can then be consumed. One disadvantage of such a device is that the consumption of the osmotic agent requires a user to replenish the osmotic source after use.

It is therefore an object of the present invention to provide portable water purification apparatus which seeks to alleviate the problems of the above-described prior art.

### BRIEF SUMMARY OF THE DISCLOSURE

In a first aspect the invention provides a water purification apparatus comprising:
i) a semi-permeable membrane capable of being contacted with a water source;
ii) a cross linked superabsorbent polymer capable of absorbing water across said semi-permeable membrane;
iii) a pressure application surface capable of transmitting pressure to the gel; and
iv) a permeable membrane through which absorbed water is capable of passing when released from the gel upon application of pressure thereto by said pressure application surface,
   wherein said permeable membrane is isolated in use from the water source by an isolation means.

In a preferred embodiment, the pressure application surface is capable of transmitting pressure to the gel without transmitting pressure to the semi-permeable membrane.

In a preferred embodiment:
i) said superabsorbent polymer is disposed in a packet comprising said permeable membrane;
ii) said semi-permeable membrane is formed into a sealably openable envelope containing said packet;
iii) said pressure application surface comprises the permeable membrane; and
iv) said isolation means comprises the envelope when said packet is in the envelope.

In a preferred embodiment said isolation means comprises an impermeable barrier. More preferably, wherein
i) said impermeable barrier comprises a container for said water source;
ii) said container includes a water outlet;
iii) said semipermeable membrane is connected to said container around said water outlet to define an envelope;
iv) said superabsorbent polymer is disposed in said envelope; and said permeable membrane isolates said superabsorbent polymer from said water outlet. Alternatively, wherein;
i) said impermeable barrier comprises a tube having a water outlet;
ii) said semipermeable membrane is connected around said tube to define an envelope;
iii) said superabsorbent polymer is disposed in said envelope; and
iv) said permeable membrane isolates said superabsorbent polymer from said water outlet.

Preferably, said permeable membrane comprises a plug in said water outlet.

Preferably, said tube is provided with a sealable cap.

In an alternative embodiment:
i) said impermeable barrier comprises a container for said water source;
ii) said container includes a water outlet;
iii) said semipermeable membrane is connected to said container around said water outlet to define a chamber;
iv) said superabsorbent polymer is disposed in said chamber;
v) said permeable membrane isolates said superabsorbent polymer from said water outlet; and
vi) said pressure application surface comprises a piston disposed in a cylinder communicating with said chamber.

Preferably, said semipermeable membrane is or forms part of a rigid wall of said chamber.

Preferably, said chamber is an extension of said cylinder.

In an alternative embodiment:
i) said semi-permeable membrane is formed into a conduit for said water, having an inlet and outlet;
ii) said superabsorbent polymer is disposed in a packet comprising said permeable membrane;
iii) said conduit passes through said packet;
iv) said pressure application surface comprises the permeable membrane; and
v) said isolation means comprises said semipermeable membrane conduit.

Preferably, said conduit is a U-tube whose ends pass through a manifold connected to said permeable membrane.

Preferably, said semipermeable membrane is a cellulose derivative. Preferably said superabsorbent polymer is cross-linked. Preferably, said superabsorbent polymer is a poly(acrylic acid).

In a second aspect the invention provides a method of purifying contaminated water comprising:
i) osmotically separating water from a contaminated water source through a semi-permeable membrane using a crosslinked superabsorbent polymer as an osmotic agent; and
ii) releasing water from said superabsorbent polymer by the application of pressure thereto.

Preferably said method further comprising isolating said step of releasing of water from said superabsorbent polymer from the contaminated water so that said released water is not re-contaminated.

Preferably, said isolating step is effected by disposing an impermeable barrier between an outlet for said released water and said semipermeable membrane

In a third aspect the invention provides the use of a crosslinked superabsorbent polymer as a renewable source of osmotic pressure in a water purification apparatus.

The term “semi-permeable membrane” includes reference to a selectively permeable membrane, a partially permeable membrane and a differentially permeable membrane. A differentially permeable membrane is a membrane which will allow certain molecules or ions to pass through it by diffusion. Any suitable semi-permeable membrane may be used in the apparatus according to the present invention. Preferably said semi-permeable membrane is a membrane designed for use in an osmosis separation process, for example a forward osmosis separation or a reverse osmosis separation. More preferably, said semi-permeable membrane comprises a hydrophilic membrane forming material, for example cellulose or a cellulose derivative. More preferably the semi-permeable membrane comprises cellulose esters, cellulose acetate, cellulose triacetate ester, cellulose triacetate, cellulose proprianate, cellulose butyrate, cellulosediacetate, or combinations thereof. Alternatively, the semi-permeable membrane comprises a cellulose composite with a thin film of polyamide, polyimide, polybenzimidazole, polyethylenimine, cellulose or cellulose derivative or other membrane material supported on a porous support made of cellulose esters, styrene, vinyl butyral, polysulfone, chlorinated polyvinyl chloride or other materials or combinations thereof.

The semi-permeable membrane has a molecular weight cut-off of less than 10,000 Daltons. The smallest microbial agents have a molecular weight of over 10,000 Daltons. Preferably the molecular weight cut off is less than 1000, more preferably less than 500, 400, 2′00, 200, 100 Daltons. Cellulose acetate membranes rated at 1000 Daltons may be suitable.

The term “crosslinked superabsorbent polymer” includes reference to any polymer that when crossed linked becomes water swellable but not water soluble. Any suitable superabsorbent crosslinked polymer may be used in the apparatus according to the present invention. Preferably the superabsorbent polymer comprises modified starch or cellulose, more preferably chitins, chitosans, carboxymethyl cellulose, carboxymethyl starch, hydroxypropyl cellulose, algin, alginate, carrageenan, acrylic grafted starch, acrylic grafted cellulose, modifications of any of these, including those in which the derivitising group is acidic or basic or aldehydic in character or which comprises carboxyl groups, sulfonic groups, sulphate groups, sulfite groups, phosphate groups, or combinations thereof. Alternatively the superabsorbent polymer comprises polyamines, polyimines, polyamides, polyquaternary ammoniums, polyasparagins, polyglutamines, polylysines, polyarginines, organic salts, aliphatic amines, aromatic amines, imines, amides, polyacrylamide, polyvinyl alcohol, ethylene maleic anhydride copolymer, polyvinylether, polyacrylic acid, polyvinylpyrrolidone, polyvinylmorpholine, polyaspartic acid, polyglutamic acid, polyquartemary ammonium salts, polyvinyl amines, polyvinyl imines, and copolymers thereof. More preferably the superabsorbent crosslinked polymer comprises poly(acrylic acid) or poly(methacrylic acid) and their neutralized salts.

Preferably the superabsorbent polymer is in particulate form, for example in granular, powder, strip, fibre or foamed form. When the superabsorbent polymer is in particulate form, the particles must be large enough to be retained by the permeable membrane when in a dried, non-swollen condition. In a preferred embodiment dry particle size will generally be at least 1% larger, and preferably at least 10% (more preferably at least twice) the size of the pores in the permeable membrane. Poly(acrylic acid)-graft-poly(ethylene oxide) is a suitable superabsorbent polymer.

The invention involves pressurizing the superabsorbent polymer to sufficient extent to exceed the osmotic pressure of the water absorbed and so that the water is released. Potentially, the application of excessive pressure could fracture the superabsorbent polymer so that some of it escapes through the permeable membrane. Alternatively, the superabsorbent polymer may be extruded through the pores of the permeable membrane on the application of excessive pressure. There are two possibilities to deal with this potential problem. The first is to provide an arrangement that limits the pressure capabale of being exerted. The second is to develop increased fracture toughness of the superabsorbent polymer, for example by crosslinking or copolymerization with tougher monomers.

The term “permeable membrane” includes reference to any membrane or fabric that can be permeated by water. Any suitable permeable membrane or fabric may be used in the apparatus according to the present invention. The membrane must be impermeable to the superabsorbent gel. Preferably the pores of the permeable membrane are 10% smaller, more preferably 100% smaller than the particles of superabsorbent polymer when in a dried, non-swollen condition. Preferably the membrane is made from a material having a high burst strength, preferably the membrane can withstand a bursting pressure that can be manually applied by an adult male gripping a bag of the membrane and including the superabsorbent gel. Indeed, a burst strength between 500 to 1500 kPa, preferably between 750 and 1000 kPa, may be appropriate, for example, about 840 kPa (120 psi). The aperture size of the permeable membrane is between 0.01 and 1 mm, preferably between 0.02 and 0.1 mm. A hole diameter of 0.05 mm is satisfactory. More preferably, the membrane comprises Gortex® or ballistic nylon, although any inert material will potentially suffice. For example, both nylon and fine woven stainless steel have been used.

The term “pressure application surface” includes reference to any surface of the water purification apparatus to which pressure may be directly applied by a user and which is capable of transmitting said applied pressure to said superabsorbent gel. Any suitable surface may be used in the apparatus according to the present invention. Preferably the pressure application surface comprises the permeable membrane.

Alternatively, the pressure application surface comprises an impermeable membrane. The term “impermeable membrane” includes reference to any membrane that does not allow passage of water therethrough. Preferably the impermeable membrane comprises non-porous polymeric sheet, more preferably poly vinyl chloride, polyethylene, vinyl chloride, polyurethane and combinations thereof.

The term “isolation means” refers to any means of isolating the permeable membrane from the water source. Any suitable isolation means may be used in the apparatus according to the present invention. In a preferred embodiment, the isolation means comprises the semi-permeable membrane. More preferably the semi-permeable membrane forms an envelope about the permeable membrane. In an alternative embodiment, the isolation means comprises the superabsorbent gel. Alternatively, the isolation means comprises the permeable membrane.

Thus, contaminated water is disposed to contact the semi permeable membrane and by forward osmosis is absorbed by the superabsorbent gel, being filtered in the process by the semi-permeable membrane. After a time, the water saturates the gel and no further water is transported into the gel. Then, pressure is applied, for example manually, to the pressure application surface so that the gel is squeezed like a sponge releasing purified water. The purified water exits the apparatus through the permeable membrane for consumption. The isolation means prevents contamination of the permeable membrane with the contaminated water.

One convenient arrangement is to dispose the gel inside the permeable membrane envelop and to dispose that envelope inside an openable enclosure comprising said semi-permeable membrane. In this event the isolation means comprises the semi-permeable enclosure and when that is sealed, the whole apparatus can be inserted into the contaminated water. When the gel is saturated, the enclosure is opened and the envelope removed. Once removed it is squeezed and the mechanical pressure applied releases water from the gel which escapes through the permeable membrane for collection into a container or direct consumption. However, such handling of the envelope may itself be a source of contamination.

A preferred arrangement provides an impermeable conduit separating the permeable membrane from the side of the semi-permeable membrane that contacts the contaminated water and by means of which the contaminated water is isolated from the permeable membrane.

Thus in the example of the present invention just given, a conduit between the permeable enclosure and penetrating the impermeable membrane may be provided through which water squeezed out of the enclosure can escape from the semi-permeable membrane envelope. All that is required is a seal between the semi-permeable membrane envelope and conduit, to ensure contaminated water cannot enter the envelope without filtering through the semi-permeable membrane. Then it is necessary to ensure that the inside of the conduit is isolated from the contaminated water. This can be arranged either by not immersing all of the conduit in the contaminated water or by providing it with a sealable cap.

In this event, it is not necessary to provide a complete enclosure of permeable membrane for the gel. Since it can in this case be contained by the semi-permeable membrane envelope. However, sufficient permeable membrane is still required to close the conduit so that gel cannot escape through it when pressure is applied to the envelope.

A further refinement is in evoluting the conduit to form a container for the contaminated water, the container in this embodiment forming one wall of the envelope and containing an aperture into the envelope closed with a plug of permeable membrane.

Water is then poured into the container in which the envelope is sited and when the gel is saturated any remaining water is poured away before pressing the envelope to squeeze the gel, water released from the gel being ejected through the permeable plug.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

### BRIEF DESCRIPTION OF THE DRAWINGS

Preferred embodiments of the present invention will now be more particularly described, by way of example only, with reference to the accompanying drawings wherein:

FIG. 1 is a schematic representation of a water purification apparatus in accordance with the first aspect of the invention, wherein the isolation means comprises a semi-permeable membrane;

FIG. 2 is a schematic representation of a water purification apparatus in accordance with the second aspect of the invention, wherein the isolation means comprises the superabsorbent gel and impermeable membrane;

FIG. 3 is a schematic representation of a water purification apparatus in accordance with the invention, wherein the isolation means comprises a tube;

FIG. 4 is a schematic representation of a water purification apparatus similar to that of FIG. 3;

FIG. 5 is a schematic representation of a water purification apparatus in accordance with the invention, wherein a piston is employed to pressurise the superabsorbent gel; and

FIG. 6 is a schematic representation of a water purification apparatus in accordance with the invention, wherein the semipermeable membrane comprises a U-tube.

### DETAILED DESCRIPTION

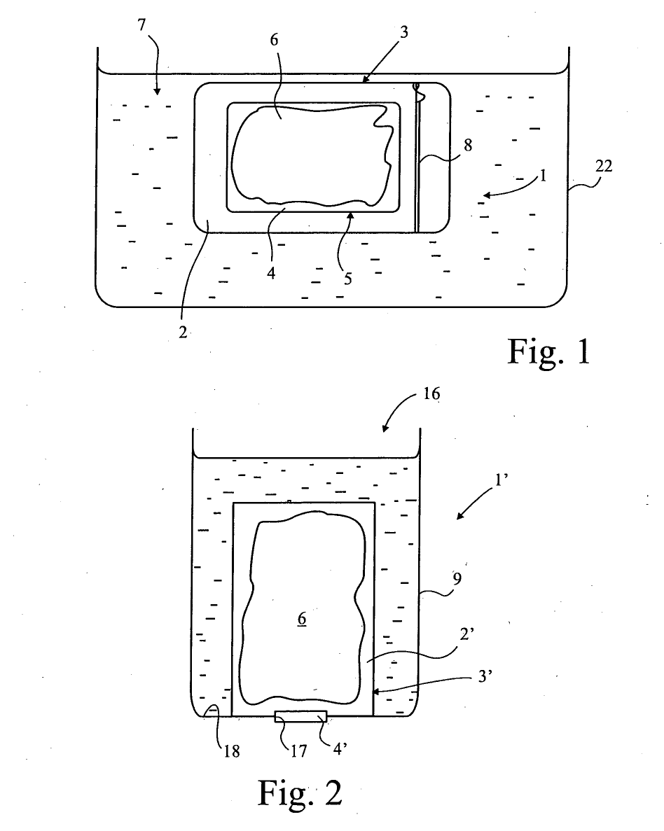

In FIG. 1, a water purification apparatus according to a first embodiment of the present invention is illustrated generally at 1. The apparatus comprises a semi-permeable membrane 2. The membrane 2 is formed into an envelope 3 inside which is disposed a closed packet 5 formed from a permeable membrane 4. The packet 5 contains a cross-linked superabsorbent polymer 6.

The envelope 3 has a sealable opening 8 (for example, a zip-type fastener) that allows access to the packet 5 disposed therein. The sealable opening comprises a water tight seal that prevents the entry of water into the envelope when the opening is sealed.

In use, the envelope containing the packet 5 is placed into contaminated water 7 in a container 22 or similar source (eg river, pond or sea), such that the semi-permeable membrane 2 of the envelope 3 contacts the water. The superabsorbent polymer 6 creates an osmotic pressure across the semi-permeable membrane which causes water to travel through the membrane 2 and the membrane 4 into the polymer 6, as a result of forward osmosis, thereby causing it to swell. The semi-permeable membrane 2 has a molecular weight cut off so as to prevent the passage of microorganisms, pesticides, organic molecules, heavy metal ions and chlorinated solvents. Accordingly, the water absorbed by the polymer 6 is potable.

The potable water absorbed by the polymer is recovered by removing the apparatus 1 from the contaminated water. The packet 4 is removed from the envelope 2 via the sealable opening 8. Preferably the packet is removed without contaminating the inside of the envelope 2 or the exterior of the packet 4 with the contaminated water.

Pressure is then applied by the user to the permeable membrane 4 of the packet 5. The application of pressure is transmitted through the permeable membrane 4 to the polymer 6 and thereby equalizes the osmotic pressure created by the polymer 6. The water is thus released from the polymer and can then be consumed. Preferably the pressure is applied directly by the user, i.e. by wringing the permeable membrane by hand. Alternatively the pressure can be applied mechanically, e.g. by the use of a mangle. Advantageously, the components of the apparatus are arranged such that potable water can be removed from the polymer, without the application of pressure to the semi-permeable membrane.

The superabsorbent polymer 6 cannot pass through the permeable membrane 4 and is thereby retained within the packet 5. In this manner the osmotic source i.e. the polymer 6 is retained in the apparatus after extraction of the water and the apparatus can be reused.

A water purification apparatus according to a second embodiment of the present invention is illustrated generally at 1′ of FIG. 2. The apparatus comprises a water container 9 formed from an impermeable plastic sheet. The container 9 comprises water receiving opening 16.

A semi-permeable membrane 2′ forms a packet 3′ within the container 9, with an inner surface 18 of the container 9 forming one wall (or more than one wall) of the packet. The packet 3′ contains a cross-linked superabsorbent polymer 6. On the inner surface 18 of the container 9 within the confines of the packet 3′, is disposed a water outlet 17.

A permeable membrane 4′ is disposed over the outlet 17. The outlet 17 is comprised within the wall of the wall of the packet 3′ and is thereby isolated from the interior of the container 3′ and the contents (unpurified water) thereof.

In use, contaminated water is placed in the container 3′ via the water receiving opening 16. The contaminated water contacts the semi-permeable membrane 2′ of the packet 3′. The superabsorbent polymer 6 creates an osmotic pressure across the semi-permeable membrane 2′, which causes water to travel through the membrane, as described previously, resulting in swelling of the polymer 6. The molecular weight cut-off of the permeable membrane is the same as described previously and thus the water absorbed by the polymer 6 is potable.

The water absorbed by the polymer is recovered by the application of pressure to the exterior of the container 9. The application of pressure is transmitted through the walls of the container and the semi-permeable membrane packet 3′ to the superabsorbent polymer 6. The applied pressure equalizes the osmotic pressure created by the polymer and absorbed water and the water is released through the water outlet 17, through the permeable membrane 4′.

The superabsorbent polymer 6 cannot pass through the permeable membrane 4′ and is thereby retained within the packet 3′. In this manner, the osmotic source i.e. the polymer 6, is retained in the apparatus after extraction of the water and the apparatus can be reused.

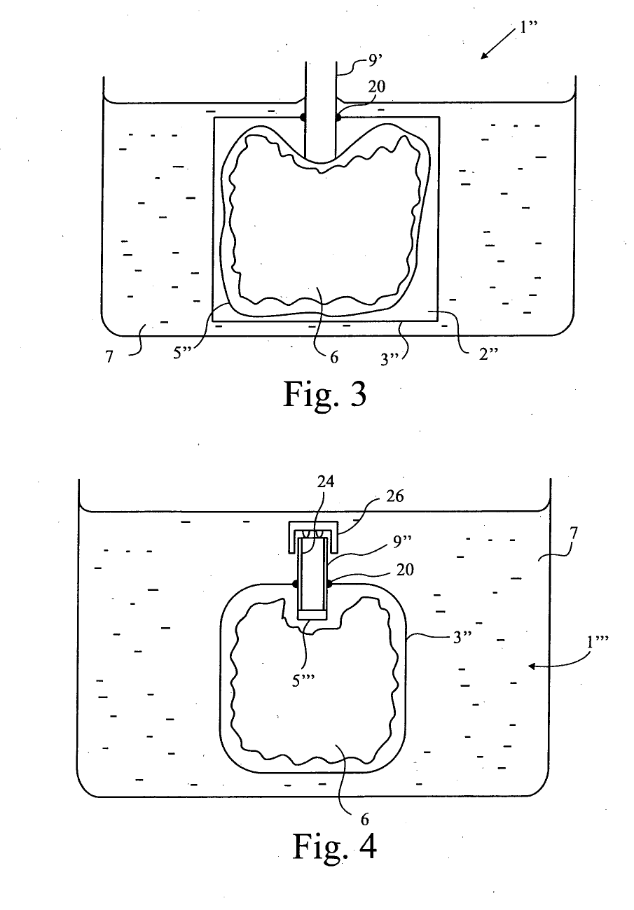

In FIG. 3, water purification apparatus 1″ comprises semi-permeable membrane envelope 3″ having an opening sealed at 20 around an impermeable tube 9′. Inside the envelope 3″ is a packet 5″ including superabsorbent polymer 6. Contaminated water 7 in a container 22 contacts the membrane 3″ but is isolated from the packet 5″ by the tube 9′, the opening 17′ of which is kept above the surface of the water 7. When the polymer is saturated, the apparatus 1″ is withdrawn from the water 7 and the envelope 3 is squeezed so that purified water is released from the gel 6 and exits the packet 5″ and envelope 3″ through the tube 9′ into a suitable container. When fully exhausted, the apparatus 1″ is ready for re-use.

In FIG. 4, a further embodiment of water purification apparatus 1″ is shown in which the permeable membrane 5″ of the FIG. 3 arrangement is reduced simply to a permeable cap 5′″ on the mouth of tube 9″. In this embodiment, the open end 24 of the tube 9″ is provided with a thread (not shown) to which a cap 26 may be screwed to seal the end 24. Thus the whole apparatus 1′″ may be immersed in the contaminated water and, when fully saturated and removed therefrom, the cap may be removed and purified water dispensed, or even directly drunk from, the tube 9″.

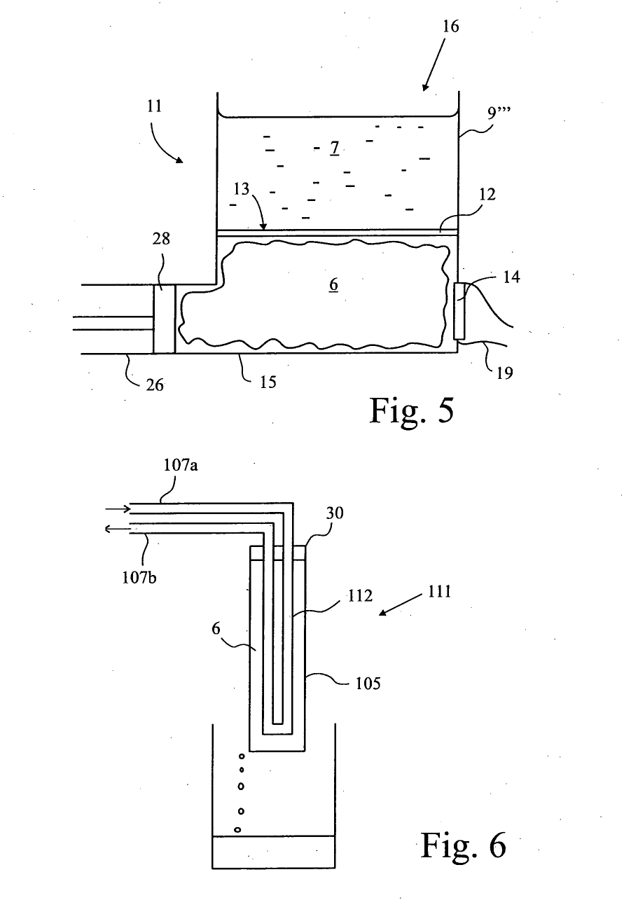

In FIG. 5, apparatus 11 comprises an impermeable container 9′″ having a rigid floor 13 formed by or including a semi-permeable membrane 12. Under the floor 13 is a compartment 15 including superabsorbent polymer 6. The compartment 15 is provided with a cylinder 26 and piston 28. Contaminated water 7 is placed in the container 9′″ in contact with the floor 13 and osmotic pressure draws water into the polymer 6 swelling it so that it expands into the cylinder 26 displacing the piston leftwardly in the drawing. When fully saturated, the piston is pressed rightwardly in the drawing pressurising the gel 6 and overcoming the osmotic pressure and thereby releasing the water from the gel. At the other end of the compartment 15 a spout 19 is arranged, closed by a permeable plug 14. The water released from the gel exits the apparatus 11 through the plug 14 and spout 19.

Finally, FIG. 6 illustrates a further embodiment of water purification apparatus 111. Here a Visking™ U-tube made by Medicell International Ltd is connected to contaminated water inlet 107a and outlet 107b. Visking is the trade name of cellulose based tubes and sheets which have a selective porosity and are employed for their osmosis capabilities. The water inlet and outlet are in a manifold 30 that is also a closure for a mesh bag 105 surrounding the U-tube 112. Inside the bag and in contact with the U-tube 112 is superabsorbent gel 6. Here, the gel is poly(acrylic acid), partial sodium salt-graft-poly(ethylene oxide) purchased from Aldrich Chemical Company (product number 432784-CAS 27599-56-0). With continuous flow of contaminated water through the U-tube 112, the pollutants not passing through the membrane of U-tube 112 are washed away.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A water purification apparatus comprising:
i) a semi-permeable membrane capable of being contacted with a water source;
ii) a superabsorbent polymer capable of absorbing water across said semi-permeable membrane;
iii) a pressure application surface capable of transmitting pressure to the polymer; and
iv) a permeable membrane through which absorbed water is capable of being released from the polymer upon application of pressure thereto from said pressure application surface,
wherein said permeable membrane is isolated in use from the water source by an isolation means.

2. The apparatus of claim 1, wherein:
i) said superabsorbent polymer is disposed in a packet comprising said permeable membrane;
ii) said semi-permeable membrane is formed into a sealably openable envelope containing said packet;
iii) said pressure application surface comprises the permeable membrane; and
iv) said isolation means comprises the envelope when said packet is in the envelope.

3. The apparatus of claim 1, wherein said isolation means comprises an impermeable barrier.

4. The apparatus of claim 3, wherein:
i) said impermeable barrier comprises a container for said water source;
ii) said container includes a water outlet;
iii) said semipermeable membrane is connected to said container around said water outlet to define an envelope;
iv) said superabsorbent polymer is disposed in said envelope; and
v) said permeable membrane isolates said superabsorbent polymer from said water outlet.

5. The apparatus of claim 3, wherein:
i) said impermeable barrier comprises a tube having a water outlet;
ii) said semipermeable membrane is connected around said tube to define an envelope;
iii) said superabsorbent polymer is disposed in said envelope; and
iv) said permeable membrane isolates said superabsorbent polymer from said water outlet.

6. The apparatus of claim 4, wherein said permeable membrane comprises a plug in said water outlet.

7. The apparatus of claim 6, wherein said tube is provided with a sealable cap.

8. The apparatus of claim 3, wherein:
i) said impermeable barrier comprises a container for said water source;
ii) said container includes a water outlet;
iii) said semipermeable membrane is connected to said container around said water outlet to define a chamber;
iv) said superabsorbent polymer is disposed in said chamber;
v) said permeable membrane isolates said superabsorbent polymer from said water outlet; and
vi) said pressure application surface comprises a piston disposed in a cylinder communicating with said chamber.

9. The apparatus of claim 8, wherein said semipermeable membrane is or forms part of a rigid wall of said chamber.

10. The apparatus of claim 8, wherein said chamber is an extension of said cylinder.

11. The apparatus of claim 1, wherein:
i) said semi-permeable membrane is formed into a conduit for said water, having an inlet and outlet;
ii) said superabsorbent polymer is disposed in a packet comprising said permeable membrane;
iii) said conduit passes through said packet;
iv) said pressure application surface comprises the permeable membrane; and
v) said isolation means comprises said semipermeable membrane conduit.

12. The apparatus of claim 11, wherein said conduit is a U-tube whose ends pass through a manifold connected to said permeable membrane.

13. The apparatus of claim 1, wherein said semipermeable membrane is a cellulose derivative.

14. The apparatus of claim 1, wherein said superabsorbent polymer is cross-linked.

15. The apparatus of claim 1, wherein said superabsorbent polymer is a poly(acrylic acid).

16-21. (canceled)

22. The apparatus of claim 5, wherein said permeable membrane comprises a plug in said water outlet.

23. The apparatus of claim 5, wherein said tube is provided with a sealable cap.

24. A method of purifying contaminated water comprising:
i) osmotically separating water from a contaminated water source through a semi-permeable membrane using a superabsorbent polymer as an osmotic agent; and
ii) releasing water from said superabsorbent polymer by the application of pressure thereto.

25. The method of claim 24, further comprising isolating said step of releasing of water from said superabsorbent polymer from the contaminated water so that said released water is not re-contaminated.

26. The method of claim 25, wherein said isolating step is effected by disposing an impermeable barrier between an outlet for said released water and said semipermeable membrane.
